(19) United States
(12) Patent Application Publication
(10) Pub. No.: US 2006/0073450 A1
(43) Pub. Date: Apr. 6, 2006

(54) Memory aid

(76) Inventor: Peter Dyer, Western Australia (AU)

Correspondence Address: GOTTLIEB RACKMAN & REISMAN PC, 270 MADISON AVENUE, 8TH FLOOR, NEW YORK, NY, 100160601, US

(21) Appl. No.: 10/527,260

(22) PCT Filed: Sep. 8, 2003
(86) PCT No.: PCT/AU03/01168

§ 371 Date: Mar. 9, 2005

(30) Foreign Application Priority Data
Sep. 9, 2002 (AU) 2002951290
Nov. 29, 2002 (AU) 2002953055

(51) Int. Cl. G09B 19/00

(52) U.S. Cl. 434/236

(57) ABSTRACT

A memory aid comprising a display having a plurality of display zones (19), each display zone adapted to provide a display independently of the other display zones, each display zone capable of sequentially displaying the letters of an alphabet and a control adapted to cause the sequential display of the letters at each display zone. An electronic device and a mechanical device and a software programme which is adapted to control a computer is claimed.

### FIELD OF THE INVENTION

This invention relates to a memory aid.

### BACKGROUND

It is often the case that due to temporary memory lapses a person is unable to remember a particular piece of information, such as the name of a person, town or location, the name of a product or the like item of information. In such instances it has been found that if a clue can be given, which provides an indication of the letters of that name that the remainder of the name will quickly follow.

### DISCLOSURE OF THE INVENTION

Accordingly the invention resides in memory aid comprising a display having a plurality of display zones, each display zone adapted to provide a display independently of the other display zones, each display zone capable of sequentially displaying the letters of an alphabet and a control adapted to cause the sequential display of the letters at each display zone.

According to a preferred feature of the invention the memory aid is an electronically operated device. According to a preferred feature of the invention a control enables the display at each display zone to sequentially display the letters and to maintain the display of a selected letter. According to a preferred feature of the invention the control includes an operator controlled first switch whereby the letter displayed can be changed sequentially. According to a preferred feature of the invention the control is adapted to cause the display zones to be activated sequentially. According to a preferred feature of the invention the control includes an operator controlled second switch whereby the display zone to be controlled by the first switch can be selected by operation of the second switch. According to a preferred feature of the invention each display zone is controlled by a separate first switch. According to a preferred feature of the invention each first switch comprises a pair of switches where each switch is able to activate the display zones to sequentially display the letters in opposite order to the other first switch.

According to a preferred feature of the invention the control comprises a computer programme adapted to control a computer and/or processor to provide a display of the of display zones and adapted to control thee display at each display zone to cause the letters to be sequentially displayed at each display and for a selected letter to be retained at the respective display zone. According to a preferred feature of the invention the control enables an operator to operate a first control whereby the letter displayed can be changed sequentially. According to a preferred feature of the invention the control is adapted to cause the display zones to be activated sequentially. According to a preferred feature of the invention the control means enables an operator to operate a second control whereby the display zone to be controlled by the first control can be selected by operation of the second control. According to a preferred feature of the invention each display zone is controlled by a separate first control. According to a preferred feature of the invention each first control comprises a pair of controls where each control is able to activate the display zones to sequentially display the letters in opposite order to the other first switch. According to a preferred feature of the invention the computer programme is incorporated into a telephone having a visual display such as a mobile phone and having a processor whereby the programme can be activated and operated by manipulation of the keypad of the telephone.

According to a preferred feature of the invention the memory aid is a mechanically operated device. According to a preferred feature of the invention the memory aid comprises a set of display elements each having a display face, the display elements associated with a display area having a plurality of display zones the display zones being in one to one correspondence with the display faces, whereby each display element is independently moveable relative to display zone to cause the display face of each display element to be moved past the display zone, each display zone bearing the letters of an alphabet and wherein each letter of a display face can be independently and selectively viewed at the display zone, the control comprising a portion of each display element which can be manually manipulated to cause the relative movement of the display elements. According to a preferred feature of the invention each of the display elements comprises a disc. According to a preferred feature of the invention the display faces comprise an axial face of the discs. According to an alternative preferred feature of the invention the display faces comprise the radial face of the discs. According to a preferred feature of the invention the discs are concentrically supported. According to a preferred feature of the invention the discs are of differing diameters and the display faces are defined by an annular zone around the outer perimeter of the disc. According to a preferred feature of the invention the display zone overlies the rotation path of the display faces. According to a preferred feature of the invention said discs are mounted in side by side relationship, the display faces are defined by an annular zone around the axial face of the respective disc and the display zone overlies the rotation path of the display faces.

According to a preferred feature of the invention the display elements comprise elongate elements which are in side by side relationship, the display elements being slidable with respect to each other, with a display face comprising the adjacent portions of the display elements.

The invention will be more fully understood in the light of the following description of several specific embodiments.

### BRIEF DESCRIPTION OF THE DRAWINGS

The description is made with reference to the accompanying drawing of which:

FIG. 1 is an exploded view of a memory aid according to the first embodiment;

FIG. 2 is a plan view of the display aid according to the first embodiment at which the outermost display element is able to be manipulated;

FIG. 3 is a plan view of the first embodiment in which the intermediate display element is able to be manipulated;

FIG. 4 is a plan view of a memory aid according to the first embodiment in which the innermost display element is able to be manipulated; and

FIG. 5 is a plan view of a further embodiment.

### DETAILED DESCRIPTION OF SPECIFIC EMBODIMENTS

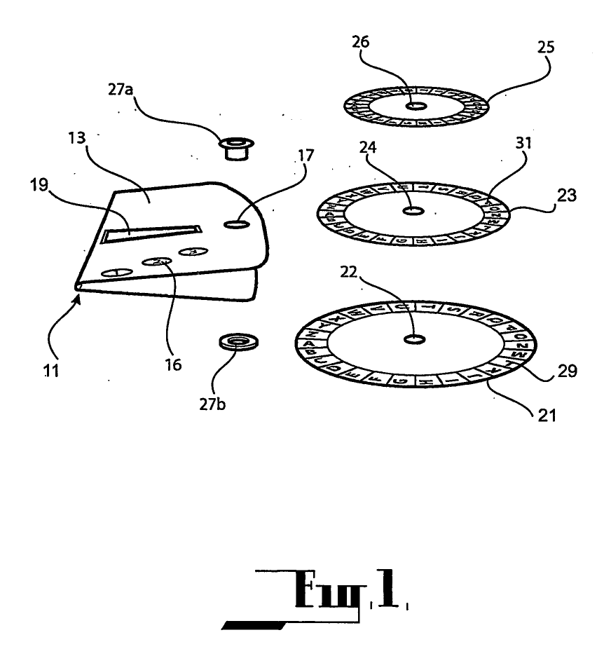

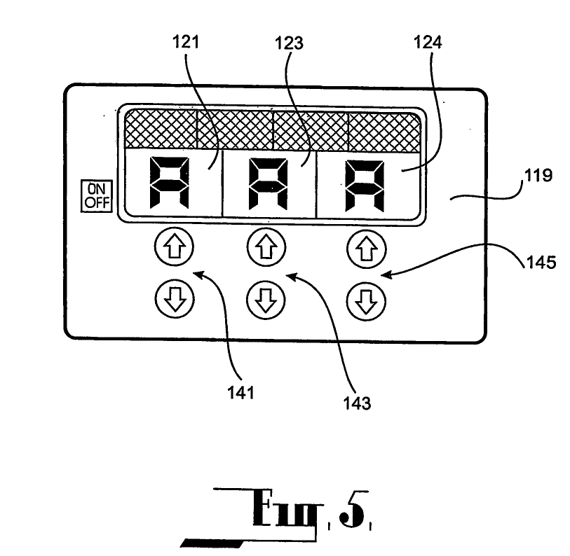

The first embodiment as shown in FIGS. 1 to 4 relates to a memory aid which can be utilised in order to attempt to recollect a name which can be the name of a person, a place, a product or the like.

The memory aid comprises a support which is formed from a laminar or sheet element which is relatively rigid and which is folded along a central line to provide a front panel 13 and a rear panel 15. The panels are each provided with an aperture 17 and the apertures of each panel are aligned and located towards an outer edge of the support. The support includes a display zone 19 which comprises an aperture formed in the front panel 13.

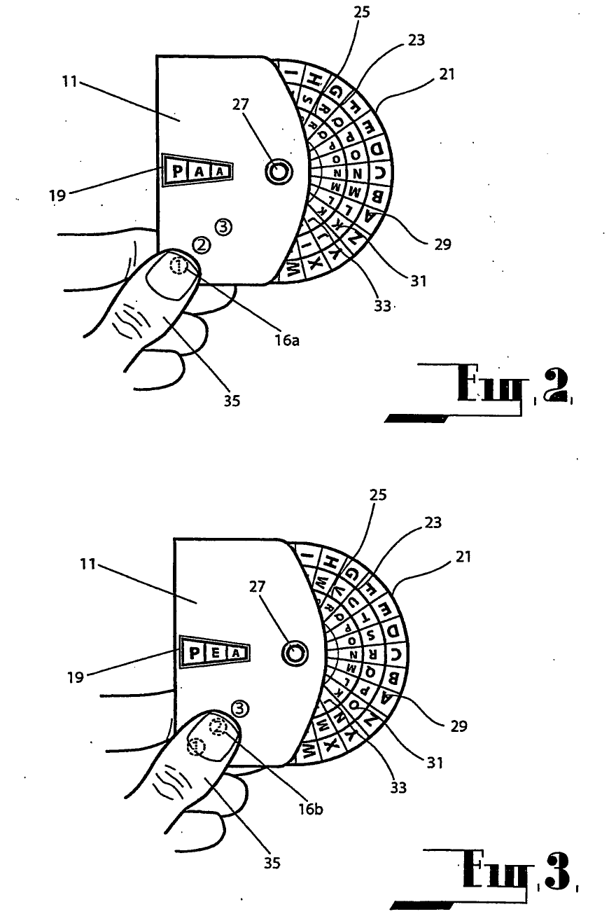

The front and rear panels 13 and 15 rotatably receive between them a set of three discs 21, 23 and 25 which are concentrically supported at their centres 22, 24 and 26 from a pivot pin 27a which receivable in the apertures 17, 22, 24 and 26 to enable the discs to be concentrically and rotatably supported between the panels 13 and 15. The pivot pin 27a is associated with a retention washer 27b which will engage the pin at the underside of the support. The discs 21, 23 and 25 are of differing diameters such that when they are stacked one upon the other as illustrated at FIGS. 2, 3 and 4 at least the outer annular portion of each disc can be observed. The outer annular portions 29, 31 and 33 which are exposed when the discs are stacked one upon the other comprise the display faces of each of the discs. The display zone 19 in the upper panel 13 of the support is located relative to the pivot apertures 17 such that it extends radially across the discs whereby segment of the outer annular portion (i.e. the display face of each disc) is observable through the display zone 19.

Each of the display faces are divided into segments which bear a letter of the alphabet. In the case of the display face 29 of the larger disc 21 the letters of the alphabet are ordered according to their order within the alphabet. In the case of the display face 31 of the intermediate disc 23 the letters are grouped such that the vowels and consonants are separated whereby the vowels are grouped according to their position within the alphabet while the consonants are ordered according to their relative ranking according to use. In the cause of the display face 33 of the smallest disc 25 the letters are ordered on the display face in the same manner as the letters are ordered on the display face of the intermediate disc 23.

As a result of the mounting of the discs within the support 11 and the interaction of each of the display faces with the display zone, the letters on each of the display faces can with manipulation be sequentially indexed past the display zone such that they can be viewed at the display zone to provide a full range of combinations of three letters of the alphabet.

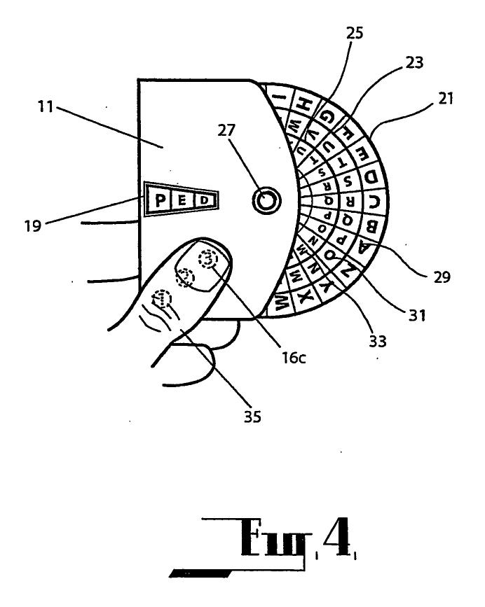

In use and as shown at FIG. 2 the outer display face 29 of the larger disc 21 is utilised to attempt to identify the first letter of the name being sought. As a result the letters of the outermost display face 29 are indexed past the display zone by rotation of the first disc 29. As each letter (eg A) is located at the display zone the user can then think of names beginning with this letter (eg Andrew, Alfred etc). If these names do not appear to be appropriate the user will then move to the next letter (B) and think of names beginning with that letter (eg Barry, Brian etc). By rotating the display face 29 past the display zone and thinking of names that begin with each letter being viewed at the display zone the user may then be able to identify the name being sought or at least the first letter of that name. When the user has identified a letter (e.g. P) which appears to be relevant to the name being sought the user will then apply pressure using the thumb and index finger to the upper and lower panels 13 and 15 at the location 16a bearing the numeral “1” which overlies the display face 29 of the larger disc 21 and lock that disc in position and will then rotate the intermediate disc and move letters past the letter displayed on the outer display zone 29 (P). Since it is most usual that the second letter of a name will be a vowel the vowels can be moved past the letter P first. In the event that the user obtains a combination of letters on the outer and intermediate display faces 29 and 31 which appear to be relevant, the user would then lock the intermediate disc by applying pressure between the upper and lower faces 13 and 15 of the support using the index finger and thumb as shown at FIG. 3 to the location 16b bearing the numeral “2”. In order to identify the third letter of the name the smaller disc 25 is caused to rotate to move the display face past the display zone. Again since it is most likely that the third letter of a name will be a vowel, the vowels can be selectively moved past the display zone first.

It has been found as a result of personal trials by the inventor that usually only three letters or less need to be identified before it is possible is able to recall the name being sought.

It should be appreciated that the scope of the present invention need not be limited to the particular spatial relationship between the discs as illustrated in the embodiment, the discs need not be concentrically supported and that the invention need not be limited to three discs.

According to a second embodiment the display faces of each of the discs are of the same diameter and have a thickness such that their outer radial face is able to accommodate a letter of the alphabet. The discs are mounted concentrically and the display face of each disc is provided by the radial face of the each disc and the display zone extends axially across the radial faces of the discs such that the radial faces can move past the display zone.

According to a third embodiment of the invention the display elements may be of an elongate configuration and they are supported to be parallel to each other and are slidable with respect to each other. The display faces comprise the adjacent edge portions of each of the elements.

A fourth embodiment as shown schematically at FIG. 5 comprises an electronic equivalent of the previous embodiments in which the display comprises an electronic device having an LCD display 119. The display comprises a set of 3 display zones 121, 123 and 125 located in a side by side, transversely extending relationship where each display is independently activated by a first pair of switches 141, 143 an 145. Each display zone is adapted to display the letters in a sequential order corresponding to the order of the letters appearing on the respective display faces of the first embodiment described above. Each display zone is provided with a pair of first switches 141, 143 and 145 whereby the display at each zone can be selectively activated by the respective pair of switches to sequentially display the letters at that zone in accordance with the sequence relevant for that zone whereby the sequence can be scrolled forwardly or rearwardly by the respective switch of each pair.

In one form of the embodiment the letters are caused to be sequentially displayed each time the respective first switch is activated whereby the user, by manipulating of each of the first switches is able to build up a set of 3 letters by sequentially activating the left hand display zone until the desired letter is found, then moving to the central display zone and then to the right hand display zone.

In another form of the embodiment the letters are caused to be sequentially displayed each for a period of time when the respective first switch is activated and will retain a desired letter on reactivation of the respective first switch. As a result the user by manipulating of each of the first switches is able to build up a set of 3 letters by sequentially activating the left hand display zone until the desired letter is found, then moving to the central display zone and then to the right hand display zone.

According to a fifth embodiment the device comprises one first switch and one second switch whereby the second switch is used to change the display zone which is to be activated by the first switch and once a display zone has been activated the letters are caused to be sequentially displayed at that display zone each time the first switch is activated. As a result the user is able to build up a set of 3 letters by sequentially activating the left hand display zone until the desired letter is found, then moving to the central display zone and then to the right hand display zone.

According to a sixth embodiment of the invention the device comprises a software package which can be installed into a computer which is able to provide a display similar to that of the first or second or third embodiment and where the scrolling of the display at each display zone and be controlled from the keyboard of the computer and/or my means of a mouse or equivalent accessory.

According to a seventh embodiment of the invention the device comprises a programme which can be installed into a computer whereby the programme of the software package is able to control the computer which is able to provide a display similar to that of the fourth or fifth embodiment and where the scrolling of the display at each display zone and be controlled from the keyboard of the computer and/or my means of a mouse or equivalent accessory.

According to a eighth embodiment of the invention the programme of the seventh embodiment is incorporated into the processor of a mobile telephone (or cell phone) having a visual display, whereby the programme can be activated from the keypad of the telephone and operated by use of the keypad. According to the embodiment the programme is accessible from the menu of the telephone and can be available under the Extras or Options sub-directory. Once accessed the display will display three (3) letter A's. The keypad can then be used to scroll through the letters of the alphabet at each location on the display in that:
keys “1” and “7” can be used to scroll up and down through the left hand letters;
keys 2 and 8 can be used to scroll up and down through the middle letters; and
keys 3 and 9 can be used to scroll up and down through the right hand letters.

The sequence of each set of letters corresponds to that of the previous embodiments

Throughout the specification, unless the context requires otherwise, the word “comprise” or variations such as “comprises” or comprising”, will be understood to imply the inclusion of a stated integer or group of integers but not the exclusion of any other integer or group of integers.

It should be appreciated that the scope of the invention need not be limited to the particular scope of any of the embodiments or the applications referred to.

1. A memory aid comprising a display having a plurality of display zones, each display zone adapted to provide a display independently of the other display zones, each display zone capable of sequentially displaying the letters of an alphabet and a control adapted to cause the sequential display of the letters at each display zone.

2. A memory aid as claimed at claim 1 wherein the memory aid is an electronically operated device.

3. A memory aid as claimed at claim 2, wherein a the control enables the display at each display zone to sequentially display the letters and to maintain the display of a selected letter.

4. A memory aid as claimed at claim 3 wherein the control includes an operator controlled first switch whereby the letter displayed can be changed sequentially.

5. A memory aid as claimed at claim 3 r wherein the control is adapted to cause the display zones to be activated sequentially.

6. A memory aid as claimed at claim 5 wherein the control means includes an operator controlled second switch whereby the display zone to be controlled by the first switch can be selected by operation of the second switch.

7. A memory aid as claimed at claim 4 wherein each display zone is controlled by a separate first switch.

8. A memory aid as claimed at claim 4 wherein each first switch comprises a pair of switches where each switch is able to activate the display zones to sequentially display the letters in opposite order to the other first switch.

9. A memory aid as claimed claim 1 wherein the control comprises a computer program adapted to control a computer and/or processor to provide a display of the display zones and adapted to control the display at each display zone to cause the letters to be sequentially displayed at each display zone and for a selected letter to be retained the respective display zone.

10. A memory aid as claimed at claim 9 wherein the control enables an operator to operate a first control whereby the letter displayed can be changed sequentially.

11. A memory aid as claimed at claim 9 wherein the control is adapted to cause the display zones to be activated sequentially.

12. A memory aid as claimed at claim 10 wherein the control enables an operator to operate a second control whereby the display zone to be controlled by the first control can be selected by operation of the second control.

13. A memory aid as claimed at claim 10 wherein each display zone is controlled by a separate first control.

14. A memory aid as claimed at claim 10 wherein each first control comprises a pair of controls where each control is able to activate the display zones to sequentially display the letters in opposite order to the other first switch.

15. A memory aid as claimed at claim 9 wherein the computer program is incorporated into a telephone having a visual display such as a mobile phone and having a processor whereby the program can be activated and operated by manipulation of the keypad of the telephone.

16. A memory aid as claimed at claim 1 wherein the memory aid is a mechanically operated device.

17. A memory aid as claimed at claim 16 comprising a set of display elements each having a display face, the display elements associated with a display area having a plurality of display zones the display zones being in one to one correspondence with the display faces, whereby each display element is independently movable relative to display zone to cause the display face of each display element to be moved past the display zone, each display zone bearing the letters of an alphabet and wherein each letter of a display face can be independently and selectively viewed at the display zone, the control comprising a portion of each display element which can be manually manipulated to cause the relative movement of the display elements.

18. A memory aid as claimed at claim 17 wherein each of the display elements comprises a disc.

19. A memory aid as claimed at claim 18 wherein the display faces comprise an axial face of the discs.

20. A memory aid as claimed at claim 18 wherein the display faces comprise the radial face of the discs.

21. A memory aid as claimed at claim 19 wherein the discs are concentrically supported.

22. A memory aid as claimed at claim 21 wherein the discs are of differing diameters and the display faces are defined by an annular zone around the outer perimeter of the disc.

23. A memory aid as claimed at claim 22 wherein the display zone overlies the rotation path of the display faces.

24. A memory aid as claimed at claim 19 wherein said discs are mounted in side by side relationship, the display faces are defined by an annular zone around the axial face of the respective disc and the display zone overlies the rotation path of the display faces.

25. A memory aid as claimed at claim 17 wherein the display elements comprise elongate elements which are in side by side relationship, the display elements being slidable with respect to each other, with a display face comprising the adjacent portions of the display elements.

26. (canceled)
